(19) United States
(12) Patent Application Publication
(10) Pub. No.: US 2012/0028608 A1
(43) Pub. Date: Feb. 2, 2012

(54) FEMTO-AP AND METHOD FOR REDUCING AUTHENTICATION TIME OF USER EQUIPMENT USING THE SAME

(75) Inventors: JEN-CHEN SU, Tu-Cheng (TW); CHENG-HSIN WANG, Tu-Cheng (TW)

(73) Assignee: HON HAI PRECISION INDUSTRY CO., LTD., Tu-Cheng (TW)

(21) Appl. No.: 12/869,771

(22) Filed: Aug. 27, 2010

(30) Foreign Application Priority Data
Jul. 28, 2010 (CN) 201010236645.7

(51) Int. Cl. H04W 12/06

(52) U.S. Cl. 455/411; 455/561

(57) ABSTRACT

A method for reducing authentication time of a user equipment (UE) in an Internet Protocol multimedia subsystem (IMS) network using a Femto access point (AP) establishes a secure channel between the Femto-AP and a gateway of the IMS network, performs a Femto-AP authentication with an authentication, authorization, and accounting (AAA) server of the IMS network through the secure channel, and obtains a number of virtual Internet Protocol (IP) addresses. The method further performs an UE authentication with the AAA server through the secure channel if the UE is a designated equipment in a whitelist of the Femto-AP.

### BACKGROUND

1. Technical Field

Embodiments of the present disclosure relate to security authentication technology, and particularly to a Femto access point (AP) and method for reducing authentication time of a user equipment (UE) in an Internet Protocol multimedia subsystem (IMS) network using the Femto-AP.

2. Description of Related Art

Currently, there is no standard user equipment (UE) authentication process in the Internet Protocol multimedia subsystem network (IMS network) using Femto-AP (i.e., Femtocell-AP). Authentication between the UE and an authentication, authorization, and accounting (AAA) server is performed using an extensible authentication protocol-authentication and key agreement (EAP-AKA) mechanism. However, under the EAP-AKA authentication mechanism, a secure channel between the UE and the AAA server must be established before the authentication starts every time. Therefore, an improved method for performing the UE authentication with the AAA server in the IMS network is desired.

### BRIEF DESCRIPTION OF THE DRAWINGS

FIG. 1 is a schematic diagram of one embodiment of a Femto-AP in communication with an IMS network.

FIG. 2 is a block diagram of one embodiment of the Femto-AP.

FIG. 3 is a flowchart of one embodiment of a method for reducing authentication time of user equipment in an IMS network using the Femto-AP.

FIG. 4 is another expression form of FIG. 3.

### DETAILED DESCRIPTION

All of the processes described below may be embodied in, and fully automated via, functional code modules executed by one or more general purpose computers or processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, or a tape drive.

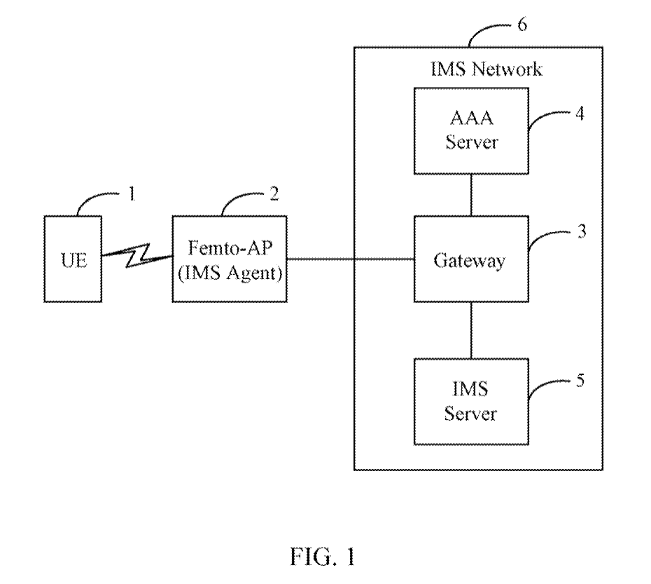

FIG. 1 is a schematic diagram of one embodiment of a Femto access point (AP) 2 in communication with an Internet Protocol multimedia subsystem (IMS) network 6. In some embodiments, the IMS network 6 may include a gateway 3, an authentication, authorization, and accounting (AAA) server 4, and an IMS server 5. The gateway 3 is connected to the Femto-AP 2, the AAA server 4 and the IMS server 5. The Femto-AP 2 is connected to a user equipment (UE) 1 through a wireless connection. In some embodiments, the gateway 3 may be a packet data gateway (PDG), the UE 1 may be a mobile phone or any other electronic device.

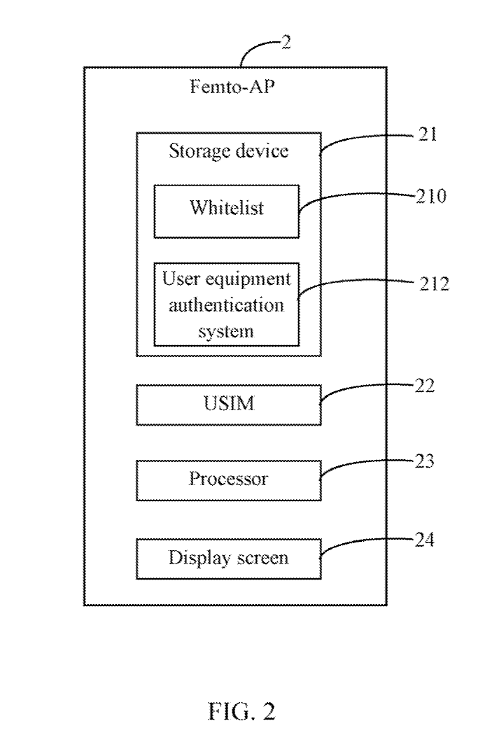

FIG. 2 is a block diagram of one embodiment of the Femto-AP 2. In some embodiments, the Femto-AP 2 may include a storage device 21, a universal subscriber identity module (USIM) 22, a processor 23, and a display screen 24. The storage device 21 may include a whitelist 210 and an UE authentication system 212. The whitelist 210 is a file that lists designated equipments, which are being provided a particular service by the Femto-AP 2. The UE authentication system 212 may establish a secure channel between the Femto-AP 2 and the gateway 3 when the Femto-AP 2 is powered on, and perform an UE authentication with the AAA server 4 through the secure channel. A detailed description will be given in the following paragraphs.

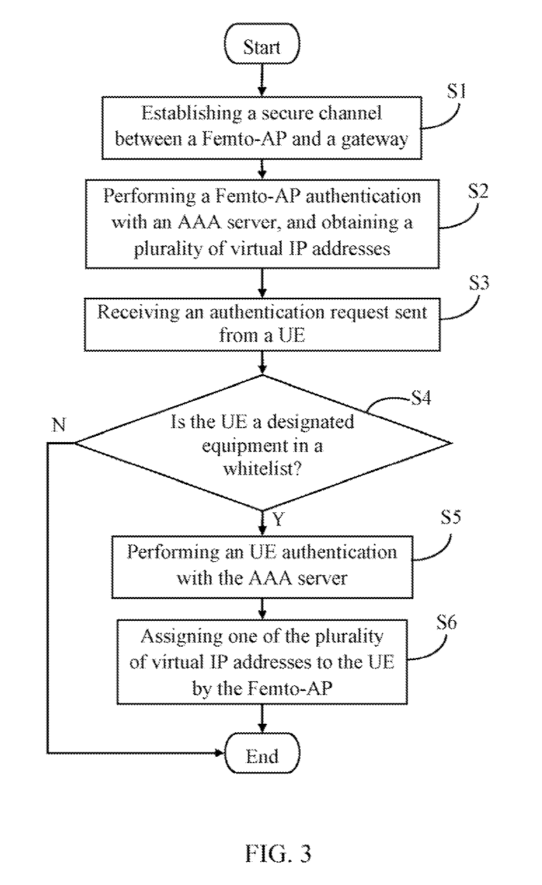

In some embodiments, the UE authentication system 212 may include one or more modules. The one or more modules are stored in the storage device 21 and configured for execution by the one or more processors (only one processor 23 is shown in FIG. 2) to execute the method in FIG. 3. The method in FIG. 3 may be performed by an electronic device (e.g. the Femto-AP 2) having a touch-sensitive display with a graphical user interface (GUI), one or more processors, a storage device and one or more modules, programs or sets of instructions stored in the storage device for performing the method in FIG. 3. In some embodiments, the electronic device provides a plurality of functions, including wireless communication, for example.

FIG. 3 is a flowchart of one embodiment of a method for reducing authentication time of the UE 1 in the IMS network 6 using the Femto-AP 2. Depending on the embodiment, additional blocks may be added, others removed, and the ordering of the blocks may be changed.

In block S1, the Femto-AP 2 establishes a secure channel between the Femto-AP 2 and the gateway 3 using a private key of the Femto-AP 2. In some embodiments, the private key is stored in the USIM 22 of the Femto-AP 2, and the secure channel is the security architecture for IP network (IPsec) channel.

In block S2, the Femto-AP 2 performs a Femto-AP authentication with the AAA server 4 through the secure channel, and obtains a plurality of virtual Internet Protocol (IP) addresses from the AAA server 4. In some embodiments, the virtual IP addresses may be 10.0.0.1/30.

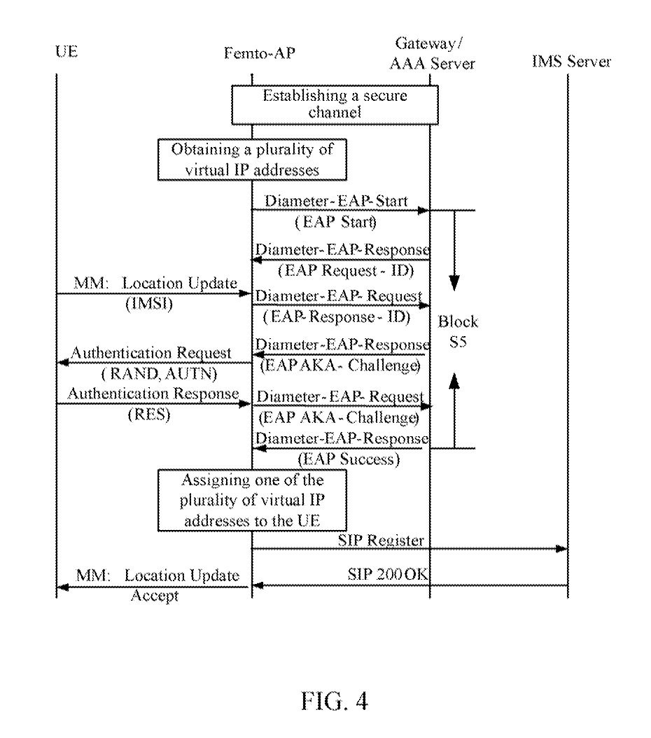

In block S3, the Femto-AP 2 receives an authentication request from the UE 1. As shown in FIG. 4, the authentication request may be a location update request to update the location of the UE 1.

In block S4, the Femto-AP 2 determines if the UE 1 is a designated equipment in the whitelist 210. If the UE 1 is the designated equipment in the whitelist 210, the procedure goes to block S5. If the UE 1 is not the designated equipment in the whitelist 210, the procedure ends. In some embodiments, the designated equipment is a qualified equipment which is provided a particular service by the Femto-AP 2

In block S5, the Femto-AP 2 controls the UE 1 to perform an UE authentication with the AAA server 4 through the secure channel. In some embodiments, the UE authentication with the AAA server 4 is performed using an extensible authentication protocol-authentication and key agreement (EAP-AKA) mechanism. A detailed description of block S5 refers to FIG. 4.

In block S6, the Femto-AP 2 assigns one of the plurality of virtual IP addresses to the UE 1 to register the UE 1 in the IMS server 5 upon the condition that the UE authentication is completed and the UE 1 needs virtual IP address for data access. In some embodiments, the register operation between the UE 1 and the IMS server 5 is performed using an session initiation protocol (SIP) mechanism. In other embodiments, the block S6 may be deleted upon the condition that the UE does not need virtual IP address for data access.

Because the UE 1 uses a pr-established secure channel to perform the authentication with the AAA server 4, it is no need to establish the secure channel between the UE 1 and the AAA server 4 before the authentication starts every time. Thus, much authentication time may be saved. In other embodiments, the aforementioned method may be performed by other suitable electronic devices, such as a Set-top box, a gateway, and a router.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for reducing authentication time of a user equipment (UE) in an Internet Protocol multimedia subsystem (IMS) network using a Femto access point (AP), the Femto-AP comprising a private key and a whitelist, the IMS network comprising an authentication, authorization, and accounting (AAA) server, a gateway, and an IMS server, the method comprising:
establishing a secure channel between the Femto-AP and the gateway using the private key of the Femto-AP;
performing a Femto-AP authentication with the AAA server through the secure channel, and obtaining a plurality of virtual Internet Protocol (IP) addresses;
receiving an authentication request from the UE by the Femto-AP;
determining if the UE is a designated equipment in the whitelist; and
performing an UE authentication with the AAA server through the secure channel if the UE is the designated equipment in the whitelist, and assigning one of the plurality of virtual IP addresses to the UE by the Femto-AP upon the condition that the UE needs virtual IP address for data access.

2. The method according to claim 1, wherein the private key of the Femto-AP is stored in a universal subscriber identity module (USIM) of the Femto-AP.

3. The method according to claim 1, wherein the secure channel is the security architecture for IP network (IPsec) channel.

4. The method according to claim 1, wherein the UE authentication with the AAA server is performed using an extensible authentication protocol-authentication and key agreement (EAP-AKA) mechanism.

5. The method according to claim 1, wherein the gateway is a packet data gateway (PDG).

6. A Femto access point (AP) used to reduce authentication time of a user equipment (UE) in an Internet Protocol multimedia subsystem (IMS) network, the Femto-AP comprising a private key and a whitelist, the IMS network comprising an authentication, authorization, and accounting (AAA) server, a gateway, and an IMS server, the Femto-AP comprising:
a display screen;
a storage device;
one or more processors; and
one or more modules stored in the storage device and configured for execution by the one or more processors, the one or more modules including instructions:
to establish a secure channel between the Femto-AP and the gateway using the private key of the Femto-AP;
to perform a Femto-AP authentication with the AAA server through the secure channel, and obtain a plurality of virtual Internet Protocol (IP) addresses;
to receive an authentication request from the UE;
to determine if the UE is a designated equipment in the whitelist; and
to perform an UE authentication with the AAA server through the secure channel if the UE is the designated equipment in the whitelist, and assign one of the plurality of virtual IP addresses to the UE upon the condition that the UE needs virtual IP address for data access.

7. The Femto-AP according to claim 6, wherein the private key of the Femto-AP is stored in a universal subscriber identity module (USIM) of the Femto-AP.

8. The Femto-AP according to claim 6, wherein the secure channel is the security architecture for IP network (IPsec) channel.

9. The Femto-AP according to claim 6, wherein the UE authentication with the AAA server is performed using an extensible authentication protocol-authentication and key agreement (EAP-AKA) mechanism.

10. The Femto-AP according to claim 6, wherein the gateway is a packet data gateway (PDG).

11. A non-transitory storage medium having stored thereon instructions that, when executed by a processor of a Femto access point (AP), causes the processor to perform a method for reducing authentication time of a user equipment (UE) in an Internet Protocol multimedia subsystem (IMS) network, the Femto-AP comprising a private key and a whitelist, the IMS network comprising an authentication, authorization, and accounting (AAA) server, a gateway, and an IMS server, the method comprising:
establishing a secure channel between the Femto-AP and the gateway using the private key of the Femto-AP;
performing a Femto-AP authentication with the AAA server through the secure channel, and obtaining a plurality of virtual Internet Protocol (IP) addresses;
receiving an authentication request from the UE by the Femto-AP;
determining if the UE is a designated equipment in the whitelist; and
performing an UE authentication with the AAA server through the secure channel if the UE is the designated equipment in the whitelist, and assigning one of the plurality of virtual IP addresses to the UE by the Femto-AP upon the condition that the UE needs virtual IP address for data access.

12. The non-transitory storage medium according to claim 11, wherein the private key of the Femto-AP is stored in a universal subscriber identity module (USIM) of the Femto-AP.

13. The non-transitory storage medium according to claim 11, wherein the secure channel is the security architecture for IP network (IPsec) channel.

14. The non-transitory storage medium according to claim 11, wherein the UE authentication with the AAA server is performed using an extensible authentication protocol-authentication and key agreement (EAP-AKA) mechanism.

15. The non-transitory storage medium according to claim 11, wherein the gateway is a packet data gateway (PDG).
